(19) United States
(12) Patent Application Publication
(10) Pub. No.: US 2025/0225569 A1
(43) Pub. Date: Jul. 10, 2025

(54) RECIPE SCANNER AND SHOPPING CART GENERATOR

(71) Applicant: Albertsons Companies, Inc, Boise, ID (US)

(72) Inventors: Nathan Gerard LAPIERRE, Halifax (CA); Balaji NAMBI, San Jose, CA (US); Nitin SAKSENA, Sunnyvale, CA (US); Laura HIGGINS, Walnut Creek, CA (US); Guangchen WANG, Surrey (CA); Jeffrey CROWE, Comox (CA)

(21) Appl. No.: 19/015,049

(22) Filed: Jan. 9, 2025

Related U.S. Application Data
(60) Provisional application No. 63/619,185, filed on Jan. 9, 2024.

(51) Int. Cl. G06Q 30/0601; G06F 40/40; G06V 30/142; G06V 30/19

(52) U.S. Cl. CPC G06Q 30/0635; G06F 40/40; G06V 30/142; G06V 30/19007; G06Q 30/0603; G06Q 30/0641

(57) ABSTRACT

Disclosed embodiments relate to a system and process by which a photograph or other image, containing written text of a recipe, can be digitized and transformed into a digital artifact, such that an e-commerce shopping cart or grocery list of required products can be automatically assembled based on the digitization.

### CROSS-REFERENCE AND PRIORITY CLAIM

This application claims priority to U.S. Provisional Patent Application Ser. No. 63/619,185, entitled “Recipe Scanner and Shopping Cart Generator” filed Jan. 9, 2024, the entirety of which is incorporated by reference.

### FIELD

Systems, methods, and machine readable media are provided for scanning recipes and automatically generating shopping carts, in particular scanning recipes, identifying ingredients in the recipes, and linking those items to a shopping cart interface and item catalog so that the items in the recipe are ready for check-out.

### SUMMARY

Disclosed embodiments relate to an application and process by which a photograph or other image, containing written text of a recipe (instructions and/or ingredients), can be digitized and transformed into a digital artifact, such that an e-commerce shopping cart or grocery list of required products can be automatically assembled based on the digitization.

A method may be provided for capturing and shopping a recipe. The method may include capturing an image of a physical recipe document using a mobile device; automatically processing the image into text and identifying and categorizing relevant information from the text as parts of a recipe; automatically comparing ingredients identified in the processed recipe parts with products available in a meal plan system to create and display a shoppable recipe, and adding the products to a shopping cart and to execute a purchase.

In some embodiments, the image of the physical recipe is captured via a camera and the processing, identifying, and categorizing is done without further intervention.

In some embodiments, the identifying and categorizing is performed using a large-language model.

In some embodiments, the method further includes executing a purchase on an ecommerce platform to purchase the products in the shopping cart.

In some embodiments, the physical recipe document is one of a printed document or handwritten document, containing additional text that is not part of the recipe.

In some embodiments, the method further comprises synthesizing missing information in the processed text based on context, such as grammar, missing words in instructions, or ingredients.

In some embodiments, the method further comprises displaying a shoppable recipe list includes the shoppable recipe ingredient amounts as well as products and amounts available in the meal plan system product catalog to meet recipe requirements.

In some embodiments, a system is provided for capturing and shopping a recipe comprising: a mobile device configured to capture an image of a physical recipe document; an application on the mobile device configured to automatically process the image into text and identify and categorize relevant information from the text as parts of a recipe; automatically compare ingredients identified in the processed recipe parts with products available in a meal plan system to create and display a shoppable recipe, and add the products to a shopping cart and to execute a purchase.

In some embodiments, the image of the physical recipe is captured via a camera on the mobile device.

In some embodiments, the application is configured to process, identify, and categorize the image captured by the camera without further intervention.

In some embodiments, the identification and categorization of relevant information is performed using a large-language model.

In some embodiments, the application is further configured to execute a purchase on an ecommerce platform to purchase the products in the shopping cart.

In some embodiments, the physical recipe document is one of a printed document or handwritten document, containing additional text that is not part of the recipe.

In some embodiments, the application is further configured to synthesize missing information in the processed text based on context, such as grammar, missing words in instructions, or ingredients.

In some embodiments, the application is further configured to display a shoppable recipe list, which includes the shoppable recipe ingredient amounts as well as products and amounts available in the meal plan system product catalog to meet recipe requirements. BRIEF

### DESCRIPTION OF THE DRAWINGS

FIG. 1 illustrates a flowchart of a method of capturing images and transforming them into shoppable recipes in accordance with the disclosed embodiments;

FIG. 2 shows a diagram of a system for capturing images and transforming them into shoppable recipes as well as integration into a shopping system in accordance with the disclosed embodiments; and

FIG. 3 shows a user interface illustrating how the scanned recipe may be automatically linked to a shoppable grocery list to execute a purchase transaction in accordance with the disclosed embodiments.

### DETAILED DESCRIPTION

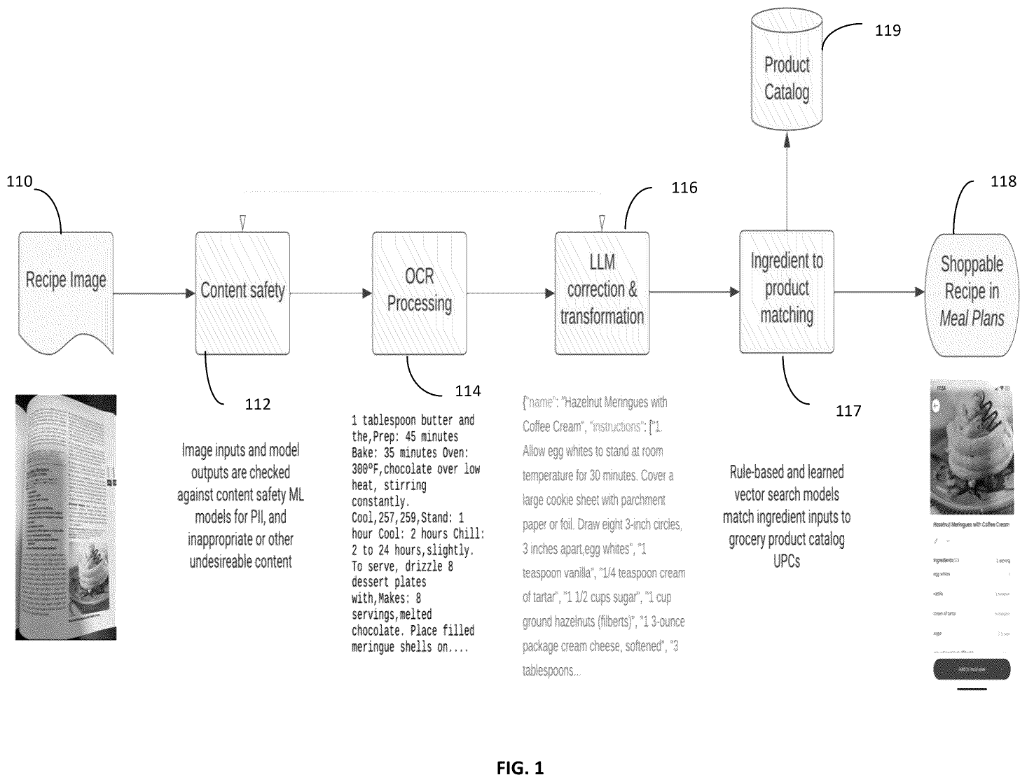

As shown in FIG. 1, a method is provided for capturing a recipe from a physical document and automatically identifying, categorizing, and correcting information in the recipe, as well as automatically extracting ingredients into a shoppable list or shopping cart without any intervention or further modification (i.e. cropping, highlighting, identification of ingredients/parts) of the captured recipe within the image. As illustrated, a recipe image of a recipe may be generated by capturing and uploading it to a system 110. This image may be captured, for example, by a camera on a mobile device. However, image files from other sources may also be uploaded to the system, which is exemplified as an application operating on a mobile device. Recipes may be in any format, whether printed publication, or handwritten on paper or recipe cards. Recipes may further be embedded in an article or other accompanying text and/or images within the captured recipe image. The captured recipe image may be content safety screened in a Machine Learning (ML) classifier for and personal identifying information, which may be masked 112. The image may be processed by an Optical Character Recognition (OCR) system to detect the any written text 114. The resulting text of the OCR process may subject to correction and transformation 116 by feeding the OCR output, along with a constructed command or prompt, into a Large Language Model (LLM). The LLM may be automatically prompted, via a prestored prompt or prompts, to perform one or more of the following functions on the OCR processed text: correct and synthesize the text to correct spelling errors, synthesize missing information based on context, such as grammar or missing words in instructions, organize the relevant recipe text into correct groups such as ingredients and instructions steps. For example, recipe steps may include an ingredient that is not listed in the ingredient section. and the LLM prompt may also include identifying key information relevant to a recipe and transform it into a machine-readable recipe format. Relevant text may include, for example, recipe steps, ingredients and amounts. In this manner, any errors in the initial recipe card, document, or file, may be corrected by the model, and any additional or extraneous information not relevant to the recipe, such as an article the recipe was embedded in, will be automatically removed

The output text of the LLM may undergo another content safety screening 112 by inputting it into a Machine Learning (ML) classifier, configured to identify if the text contains objectionable material, such as unsafe ingredients. If detected, the process is aborted to prevent abuse of the system.

The machine-readable recipe, including ingredients identified by the LLM, may be automatically fed into a meal plan system where ingredients may be matched to products 117, for example in a product catalog database 119, and saved as a shoppable recipe within the meal plan system 118. The matching may include saving either the name or ID attribute of each ingredient with a corresponding match in the product catalog. This process of matching ingredients to the product catalog databased may be repeated each time a user selects a “shop the recipe” or other button on the saved shoppable recipe in order to ensure relevant in-stock matches and pricing. The meal plan system may include rules-based or machine learning models, ecommerce product catalogs, and memory for storing shoppable recipes. Rules-based or ML models may be used to query a grocery product catalog corresponding to at least one ecommerce vendor and generate a shoppable recipe. In some embodiments, rule-based and learned vector search models may match the ingredients in the machine-readable recipe to grocery product catalog UPCs. The shoppable recipe may display a list of the ingredients or products in the recipe to be purchased without further user input. The shoppable recipe may also contain and display, for example, the text of the full recipe broken into identified steps. The shoppable recipe may be editable, for example if the user finds that his oven temperature or a different ingredient amount is preferable. Additionally, an ecommerce grocery cart may be generated with each identified ingredient from the recipe ingredient list, quantity or amount to be purchased based on amount or quantity needed in the recipe and the units in which the ingredient is sold, and a suggested product and price from the catalog. The suggested product may be swapped out with pre-identified alternative products, e.g. different brands, amounts, and prices available in the ecommerce grocery product catalog, so that the ingredients may be immediately purchased as part of a commercial transaction and delivered, shipped, or otherwise organized for pickup. The shoppable recipe may be saved in a shoppable recipes module of a meal planning system. A custom AI-generated image may also be created with the shoppable recipe to be saved based on any of the recipe title or recipe text.

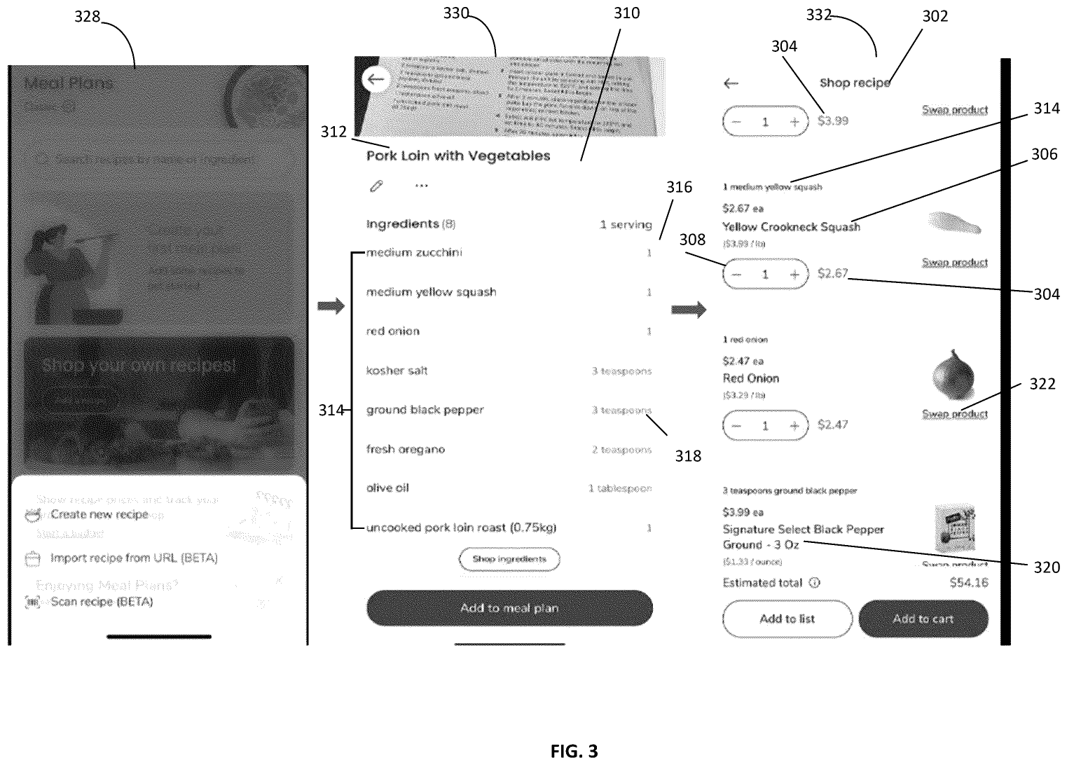

As illustrated in FIG. 3, a recipe is scanned using the camera to generate an image as described in FIG. 1 in first display 328 and automatically generates the shoppable recipe display 330. By selecting “shop ingredients” or another button in the shoppable recipe list display a shoppable recipe list display 332 appears. The shoppable recipe 330 may be revisited and reused within the meal planning system to generate the ecommerce shopping list by selecting a button such as “shop the recipe” or “shop ingredients” to prompt the rules-based or ML models to query a grocery product catalog and generate the grocery cart, or shoppable recipe list 302, with corresponding prices 304, products 306, and amounts 308 as seen in FIG. 3. The user interface, such as the display in the mobile device, shows the generated shoppable recipe 310 including title 312, ingredients 314, and amounts 316. The shoppable recipe list 302 includes a product quantity or amount based on the required ingredient amount 316 in the shoppable recipe 310. For example, the shoppable recipe list 302 shows both the 3 teaspoons of ground black pepper 318 required in the shoppable recipe 310 as well as the salable unit amount available for purchase that most closely meets that requirement black pepper ground—3 oz 320. Swap product links 322 are displayed by each product 306 to show other options available for that product from the ecommerce catalog. Moreover, items can be removed via the quantity button 324 if the user already has an ingredient. By selecting the add to cart button 326, the user may enter payment information and the order will be sent to the ecommerce vendor platform associated with the product catalog for purchase. The shoppable recipe list 302 further displays the respective ingredient 314, and amount 316 from shoppable recipe 310 for ease of comparison to the available product 306 and amount 308.

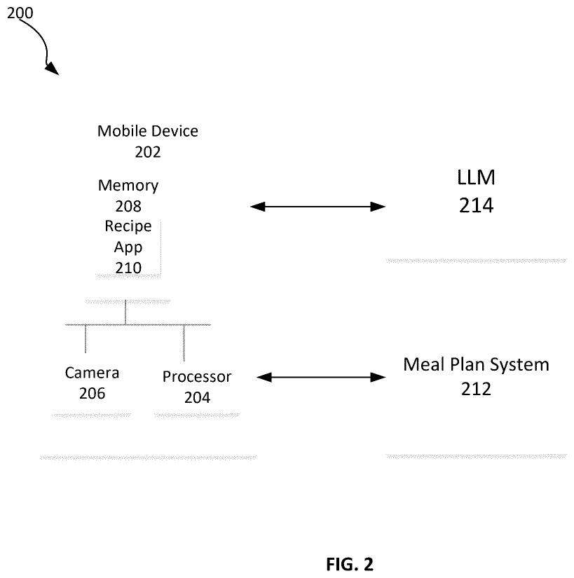

FIG. 2 shows an illustrative embodiment of the recipe scanning and shopping system 200. A mobile device, such as a laptop, tablet, or smartphone, 202 may include its standard processor 204 in communication with a camera 206 and memory 208. A recipe application 210 may include instructions for executing the operations discussed above in FIG. 1. The mobile device 202 may be in communication with a meal plan system 212, such as the meal plan system discussed in FIG. 1. The mobile device may further be in communication with one or more large-language models LLM 214. The LLM may be, for example, part of the Microsoft Azure OpenAI platform.

Those skilled in the art will recognize, upon consideration of the above teachings, that the above exemplary embodiments may be based upon use of one or more programmed processors programmed with a suitable computer program. However, the disclosed embodiments could be implemented using hardware component equivalents such as special purpose hardware and/or dedicated processors. Similarly, general purpose computers, microprocessor-based computers, micro-controllers, optical computers, analog computers, dedicated processors, application specific circuits and/or dedicated hard wired logic may be used to construct alternative equivalent embodiments. The mobile device in particular may be any of a smart phone, tablet, or other portable electronic device.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out he above-described method operations and resulting functionality. In this case, the term “non-transitory” is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

Although the invention has been explained in relation to various embodiments, it is to be understood that many other possible modifications and variations can be made without departing from the spirit and scope of the invention.

1. A method for capturing and shopping a recipe comprising:
capturing an image of a physical recipe document using a mobile device;
automatically processing the image into text and identifying and categorizing relevant information from the text as parts of a recipe;
automatically comparing ingredients identified in the processed recipe parts with products available in a meal plan system to create and display a shoppable recipe, and adding the products to a shopping cart and to execute a purchase.

2. The method of claim 1, wherein the image of the physical recipe is captured via a camera and the processing, identifying, and categorizing is done without further intervention.

3. The method of claim 1, wherein, the identifying and categorizing is performed using a large-language model.

4. The method of claim 1, further comprising, executing a purchase on an ecommerce platform to purchase the products in the shopping cart.

5. The method of claim 1, wherein the physical recipe document is one of a printed document or handwritten document, containing additional text that is not part of the recipe.

6. The method of claim 1, further comprising synthesizing missing information in the processed text based on context, such as grammar, missing words in instructions, or ingredients.

7. The method of claim 1, further comprising displaying a shoppable recipe list includes the shoppable recipe ingredient amounts as well as products and amounts available in the meal plan system product catalog to meet recipe requirements.

8. A system for capturing and shopping a recipe comprising:
a mobile device configured to capture an image of a physical recipe document;
an application on the mobile device configured to
automatically process the image into text and identify and categorize relevant information from the text as parts of a recipe;
automatically compare ingredients identified in the processed recipe parts with products available in a meal plan system to create and display a shoppable recipe, and
add the products to a shopping cart and to execute a purchase.

9. The system of claim 8, wherein the image of the physical recipe is captured via a camera on the mobile device.

10. The system of claim 9, wherein the application is configured to process, identify, and categorize the image captured by the camera without further intervention.

11. The system of claim 8, wherein the identification and categorization of relevant information is performed using a large-language model.

12. The system of claim 8, wherein the application is further configured to execute a purchase on an ecommerce platform to purchase the products in the shopping cart.

13. The system of claim 8, wherein the physical recipe document is one of a printed document or handwritten document, containing additional text that is not part of the recipe.

14. The system of claim 8, wherein the application is further configured to synthesize missing information in the processed text based on context, such as grammar, missing words in instructions, or ingredients.

15. The system of claim 8, wherein the application is further configured to display a shoppable recipe list, which includes the shoppable recipe ingredient amounts as well as products and amounts available in the meal plan system product catalog to meet recipe requirements.
